(19) United States
(12) Patent Application Publication
(10) Pub. No.: US 2008/0075565 A1
(43) Pub. Date: Mar. 27, 2008

(54) Machining line

(76) Inventor: Burkhart Grob, Bad Worishofen (DE)

Correspondence Address: JACOBSON HOLMAN PLLC, 400 SEVENTH STREET N.W., SUITE 600, WASHINGTON, DC, 20004, US

(21) Appl. No.: 11/902,257

(22) Filed: Sep. 20, 2007

(30) Foreign Application Priority Data
Sep. 20, 2006 (DE) 10 2006 044 723.9
Feb. 21, 2007 (DE) 10 2007 008 480.5

(51) Int. Cl. B65G 47/24; B65H 11/00

(52) U.S. Cl. 414/222.13; 198/345.3

(57) ABSTRACT

The invention refers to a machining line, in particular a transfer line or assembly line, comprising a multitude of machining stations arranged one after the other in the direction of machining, and the machining station serves for machining work pieces, wherein at least one machining station is designed as special station. The invention is characterised by the fact that between two adjoining machining stations one conveying device each is provided.

### BACKGROUND OF THE INVENTION

The invention refers to a machining line, in particular a transfer line or assembly line, comprising a multitude of machining stations arranged one after the other in the direction of machining, and the machining station serves for the machining of work pieces, wherein at least one machining station is designed as special machine.

Machining lines as described in the beginning are, as mentioned, known sufficiently, for example, as transfer lines in the state of the art.

Transfer lines are characterised here by the fact that the work pieces are machined one after the other by machining stations designed as special machining tools, and the conveying or transfer of the individual work pieces between the individual machining stations is carried out by a transfer rod or a transfer girder for all work pieces simultaneously. This concept proven in the state of the art, however, is inconvenient with respect of the consumption of energy. Because of the fixedly predetermined conveying sequence, where all work pieces are conveyed one station further, all work pieces have to be clamped hydraulically by the clamping device at the same time. The consequence of that is that at a certain time a high capacity of the hydraulic pump is required which has to be dimensioned, of course, exactly for this peak load. Also all other resources, e.g. pneumatic or electric equipment, have to be dimensioned for this punctual peak load which is given because of the fixed cycle operation process of the transfer line.

Furthermore a transfer line is characterised by the fact that the machining stations are provided at a fixed distance to each other as the transfer girder eventually extends from the first to the last machining station through the entire transfer line. The smallest distance between the individual machining stations therefore is defined with respect to the largest individual machining station, and there is the risk that often space is wasted. Similar aspects can be seen with an interim station if, for example, a work piece has to be supplied between two machining stations for measuring purposes, a single grid space has to be provided for that where usually a machining station is arranged. By means of that unnecessarily the entire length of the transfer line is enlarged, the halls where these transfer lines are placed have to be dimensioned accordingly.

In the state of the art a transfer device is known for a cyclewise movement and positioning of work pieces in a machining center comprising several machining stations arranged one after the other. The solution according to this state of the art is characterised, as the title already reads, by a cyclewise conveying of the work piece carriers to the individual machining stations. The return of the slides is also carried out cyclewise.

Furthermore a device for removing and supplying of machined parts is known. This device is characterised by a horizontally orientated crosshead, fastened in built-in condition at the ends stationary to two adjoining presses, which carries a carriage which can be shifted on it horizontally with a vertically shifting lifting column at the free end of which over a turning axis, which is orientated in its longitudinal direction diverting from the vertical axis, a lug carrying at its free end the work piece receiving device is fastened.

Furthermore a solution is known in the state of the art referring to a tool machine system comprising a multitude of machining stations, a shifting loading and unloading device and a run on which a loading and unloading device can shift. The loading and unloading device is characterised by the fact that a lug is arranged on it which conveys the machined work pieces into the individual machining stations and removes them again after machining.

The transfer lines are, as a rule, dimensioned for very large piece numbers, and the machining stations used in the transfer lines are specialised for special machining procedures and designed as special machine tools.

Short Abstract of the Invention

Coming from the state of the art described before it is an object of this invention to develop a machining line in such a way that its consumption of energy is lower.

In order to solve this problem the invention suggests a machining line as described before wherein in that between two adjoining machining stations a conveying device each is provided which is characterised by the fact that the conveying movement of a first work piece between a first and a second machining station is carried out independently from the conveying movement of a second work piece between the second and third machining station.

As described all energy-consuming elements are dimensioned for the peak load occurring because of the cycled way of operation, and are thus during a cycle only active in certain intervals. The rest of the time these aggregates remain in a suitable waiting position. By the suggestion according to the invention that one conveying device each is provided between two adjoining machining stations, the fixed, rigid coupling in the machining cycle in the transfer line is broken. This turning away from an essential feature of the transfer line leads surprisingly to the fact that the load for the individual energy-consuming aggregates (like hydraulic pump) becomes steady and load peaks are reduced. The result is that essentially smaller hydraulic and pneumatic installations may be provided, and even the power supply can be dimensioned accordingly smaller. Besides a reduction of the consumption of energy, of course, also the costs for constructing a machining line according to the invention are reduced as the aggregates to be used do not have to be dimensioned anymore in the known size.

However, these are not the limits of the invention. By knowingly deleting a transfer rod connecting all machining stations to one another also the rigid grid size where a machining station has to be provided is dissolved. The individual conveying devices connecting the machining stations may have basically different conveying lengths so that the arrangement of the machining stations may be closer and thus more space saving without limiting the access of the individual machining stations, for example for maintenance purposes and so on.

As a rule the machining time in the machining stations differs. Thus the result is that a first work piece is conveyed out of a first machining station prior to a second work piece out of a second machining station. As the two conveying devices are independent from each other or one conveying device each is provided with two adjoining machining stations, the loading or unloading procedure of the machining station is disengaged from each other. A simultaneous clamping of the work pieces in the machining stations then is no more the rule but a particular case, the hydraulic aggregate runs more continuously with smaller stress peaks. This goes, of course, in the same way for all other aggregates.

In the state of the art a transfer device has become known which also comprises a control device which controls the shifting movements of the slides and operates the coupling elements. In the solution according to the state of the art, however, all slides are moved at the same time or almost at the same time with the each time coupled work piece carrier from the starting in the end position. The work piece carriers then are disengaged from the slides resting in the end positions, and fixed in the engaging region of the machining station so that the machinings can be carried out. In the meantime the slides are moved back from their end positions in the start positions and the work piece carriers are coupled in the start positions to the slides. The operating processes described before in the state of the art each form an operation cycle the cycle time of which consists of a time share for the run of the work piece carrier from one machining station to the next one, and a work piece holding time for the machining of the work piece in the machining station. It is obvious that the solution known from the state of the art cannot achieve what now is achieved with the machining line according to the invention, namely carrying out the conveying movement of a first working piece between a first and a second machining station independently from the conveying movement of a second work piece between the second and third machining station. The invention is actually characterised by the fact that the movement processes can be carried independently from one another so that cycle times described before are not necessary, and altogether supplying of the machining stations can be done essentially earlier than described in the state of the art. This is achieved in particular by the positioning possible independently from each other and/or sending the work pieces to the machining stations.

Surprisingly it is successfully carried out with the arrangement according to the invention also to do without the interim places of deposit for the work pieces present in the state of the art. The interim places of deposit are necessary, for example, as testing points, for example to check whether a certain machining, for example a drilling and so on, has been really carried out. This testing cycle is regularly much shorter than the actual machining, however, it required in the state of the art its own station, and thus bounded additional work pieces in the machining line.

By means of the invention suggested now as an additional effect it is reached that providing of a space consuming interim place of deposit is saved, and, at the same time, considerably less work pieces are in the machining line. According to the invention you get the interim place of deposit for free, that means that the work piece removed here from a first machining station is conveyed by the first conveying device to the second machining station, and then is supplied before the second machining station on the conveying device. In this position it is possible, for example, to carry out suitable testing steps without requiring additional space and so on for that.

The work piece to be machined is here already directly before the second machining station, and the machining station can be loaded immediately after the second machining station has finished the work piece machining before with this second work piece. Compared with the transfer line according to the state of the art all work pieces are in the same relative position to the respective machining stations, that means after finishing the machining (for all machining stations) the following work piece is still at the exit of the machining station located before in the direction of machining. That means that, first of all, the work piece can be approached, and, after that, it can be conveyed into the machining station which requires accordingly more time for machining.

The suggestion according to the invention also leads to a higher efficiency of the machining line according to the invention.

To put it short the suggestion according to the invention is characterised by the fact that the result is a machining line which can be placed spatially flexibly, the space required by it can be optimised freely, the consumed energy of which is less and the efficiency of which or the capacity is higher than in the state of the art.

Furthermore the invention makes it possible that testing is possible without loss a cycle time. During the difference between the machining time and the transfer time, that means the time between the conveying of the work piece from a first to a second machining station, sufficiently time remains, if necessary, for carrying out suitable tests.

In the same way it is now, according to the invention, also possible that the work piece can be rotated between two stations, for example around a vertical or also a horizontal axis, and this is carried out without additional loss of time or an additional separate station which requires space.

The invention is furthermore characterised by the fact that now a machining line or a transfer line of any length can be constructed. With the conventional transfer lines it has to be taken into consideration that the transfer rod running through all machining stations can get longer because of developing heat. These differences of the measures of course influence the conveying effect and finally limit the complete length of a possible, conventional machining line according to the state of the art.

Therefore the invention can be used in any type of machining lines, for example in transfer lines or assembly lines.

Furthermore it is now possible with the invention that in the machining station also a circular table is provided for the clamping device as in the machining room of the machining station now there is no continuous transfer rod.

According to the invention it is suggested that at least one machining station is designed as special machine. Here several, a large part or all machining stations can be designed as special machines, wherein according to the invention a special machine is for example a special machining tool or an assembly machine. A special machine of this type differs from a flexibly working machining center by the fact that the special machine is adapted for a special application and cannot be used flexibly for other machinings. By means of that corresponding special machines reach fast machining times as a time consuming change of tools as it is provided with machining centers because of the system is saved.

It is provided according to the invention that the conveying movement of a first work piece between a first and a second machining station is carried independently from the conveying movement of a second work piece between the second and third machining station. Basically the conveying movements, that means the transfer of a work piece between the respective machining stations, now are carried out disengaged according to the invention. This depends on the fact that the machining in the respective machining station is finished, and the conveying device is free for receiving the work piece, that means, for example, it is not blocked by another work piece which cannot yet be conveyed into the following machining station.

According to the invention it is here, according to a convenient development, provided that the conveying device removes the work piece from the machining station, and/or puts it in the machining station or its clamping device. The use of a separate gripper which takes the work piece out of the machining station and puts it on the conveying device is avoided by this, the cycle times increase accordingly.

In a modification according to the invention it is provided here that a combined linear and swinging movement of the work piece is carried out by the conveying device. The superimposing of the swinging movement with the linear movement can be used by the use of an intelligent control for effecting two linear movements orthogonal to each other. Alternatively it is provided here that the conveying device has, for example, also a cross table through which a second orthogonal axis results. However, by the combination of a linear and a swinging movement the range of the conveying device increases or its required length is shortened. The conveying device here does not only serve for the transfer alone but it serves also, as already described, for changing and exchanging the work piece into the respective machining station.

As a rigid transfer girder is no more provided for conveying, by means of which the corresponding grid length is given, an optional distance between the machining stations is the result of the invention.

An advantageous development of the invention is characterised by the fact that the conveying devices are supported on consoles provided at the machining stations. The effect is that the conveying devices are connected safely with the machining stations and, at the same time, the effort for setting up the conveying device is lowered.

The invention comprises furthermore also a conveying device for a machining line as described. In the state of the art for machining lines of this type, for example, transfer rods or transfer girders are known as conveying devices. As described these lead to the strong coupling of the single machining steps and to the problems resulting from that. Furthermore for machining lines the use of friction roller conveyors is known where the good, the work piece or work pieces clamped on pallets is conveyed on driven roller conveyors. A disadvantage of these arrangements is the fact that for placing the work piece in the machining station a separate device has to be used. In order to improve this state of the art the invention suggests that the conveying device, as described before, has at least one slide which can be positioned on a guide rail, and a lug which can be lifted or lowered, in particular be swung, and that the lug holds the work piece either directly or indirectly, which is characterised by the fact that a swivel joint is provided below a guide rail, and a base plate holds the first part of the swivel joint, the other part of the swivel joint being provided on the side of the guide rail opposite the slide.

However, the invention is not focused only on a conveying device for a machining line, as described before, but it also comprises a conveying device for a machining line wherein the conveying device has at least one slide which can be positioned on a guide rail, and a lug which can be lifted and lowered and, in particular be swivelled, and the lug holds the work piece which is characterised by the fact that a swivel joint is provided which is provided below a guide rail, and a base plate of a base holds the first part of the swivel joint, and the other part of the swivel joint is arranged on the side opposite the slide. This solution can also be used without any problems in other machining lines. The advantages described before of the solution according to the invention will occur in the same way.

The work piece often has to be placed in a clamping device or lifted from it. Besides the transfer movement of the work piece often carried out horizontally thus a movement rectangular to the transfer movement is required. The use of a swinging lug has the advantage that the swinging movement also contains a certain part in the direction of the linear movement, and thus the range of the conveying device altogether can be increased accordingly.

By a cleverly designed control here although an exactly vertical movement is reached where the lug is swivelled and the slide(s) is/are counter-positioned accordingly on the guide rail. Such a movement supports an exact placing or removing of the work piece in the machining station.

Cleverly here lifting or lowering is realised by a turning movement around a horizontal axis.

The lug suggested according to the invention which holds the work piece may hold it directly or indirectly. According to the invention it is also suggested that the lug has a receiving table for the work piece, and the lug is realised for a parallelogram guide. The two parallel extending lug rods here end on both sides at the receiving table and, on the other side, at the base carrying the slide. By the use of the parallelogram guide it is achieved that the receiving table is orientated in the same way independently from the swivelling position of the lug, and is orientated preferably horizontally.

The invention is also characterised by the fact that the lug rods are supported flexibly in base joints in the base. Alternatively it is furthermore provided to design two table joints through which the lug rods are connected flexibly with the receiving table.

It is also an advantage if the distance of the base joints corresponds with the distance of the table joints.

It is also an advantage if a swivelling drive is provided through which the lug along a swing line can be controlled swinging and be positioned.

In another modification the invention suggests that at least one positioning support is provided at the receiving table interacting for a safe support of the work piece, in particular during transfer.

The carrying device according to the invention here is characterised by an upright as well as a suspended arrangement.

Alternatively furthermore it is suggested according to the invention that the carrying device can be rotated around a vertical axis. By means of such a design it is achieved that, for example, a work piece also can be conveyed out, or the machining way can be equipped with a switch. It is suggested here that the base is rotated with reference to the slides. In another modification the entire conveying device is swung.

In a modification the invention is characterised by the fact that between the base and the slide a swivel joint is provided by means of which the base together with the lug arranged at it can be rotated around a rotational axis orientated vertically.

Another design provides here that the slides are connected to each other by a connecting plate.

Furthermore the invention suggests that the connecting plate carries a part of the swivel joint, and the other part of the swivel joint is arranged on the underside of the base.

It is furthermore convenient if the lug rods are bent at right angles or have recesses.

According to the invention the conveying device is provided between the machining stations. In order to make assembling the conveying devices easier and, in particular, to save a separate stand foot for the conveying devices it is provided that the machining stations have suitable consoles which support the conveying devices.

### BRIEF DESCRIPTION OF THE DIFFERENT VIEWS OF THE DRAWINGS

In the drawings the invention is shown schematically. In the drawings:

FIGS. 1a to 1k In ten figures each time a schematic side view of the machining line in different machining positions according to the invention and

FIGS. 2 to 5 each a side view of different modifications of the conveying device according to the invention.

### DETAILED DESCRIPTION OF THE PREFERRED DESIGN

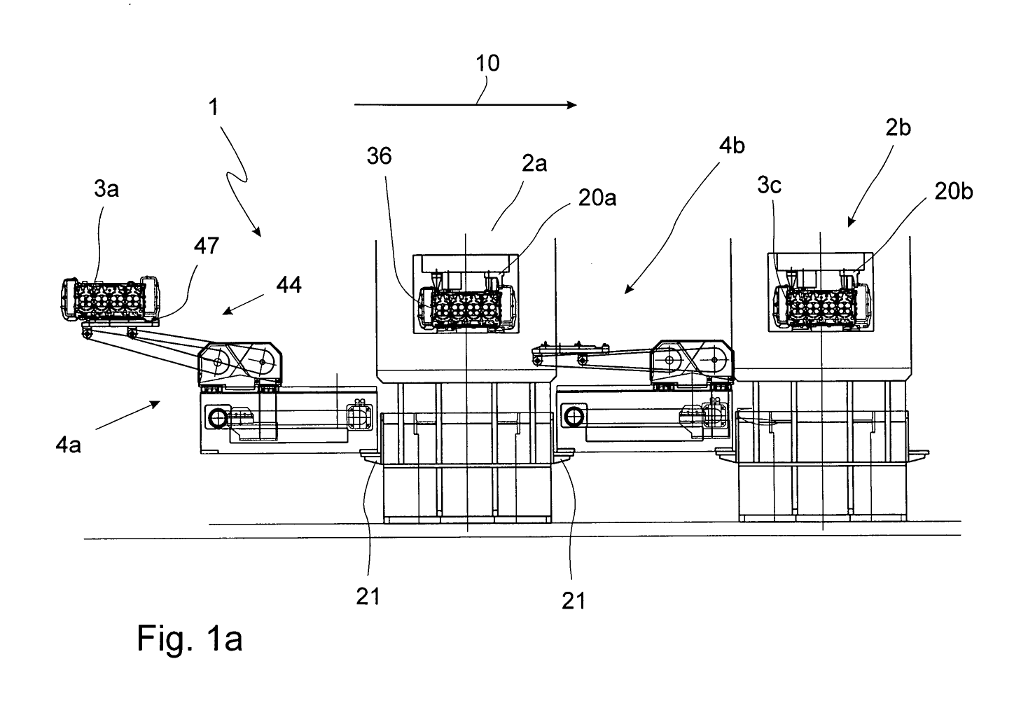

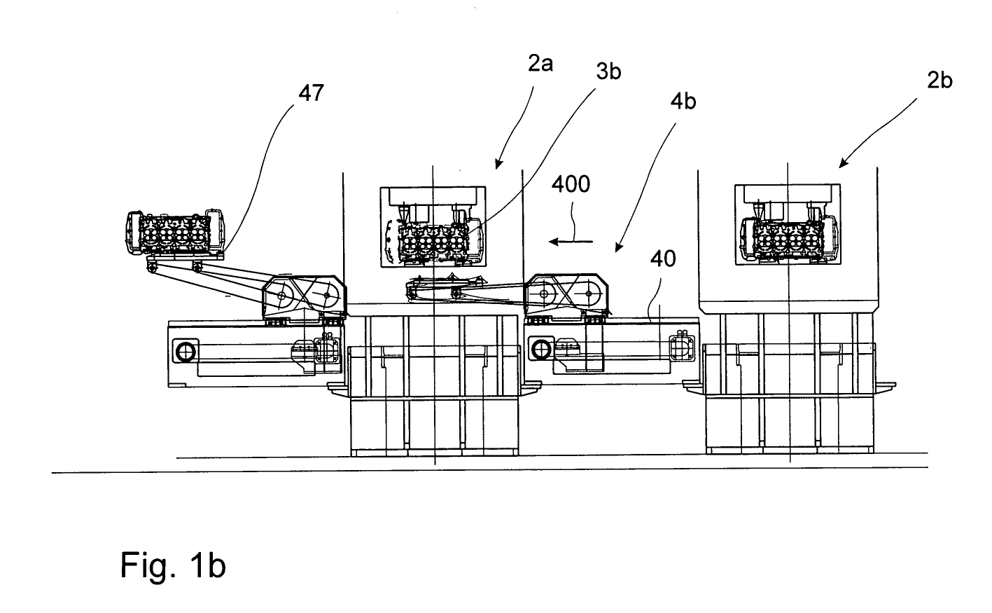

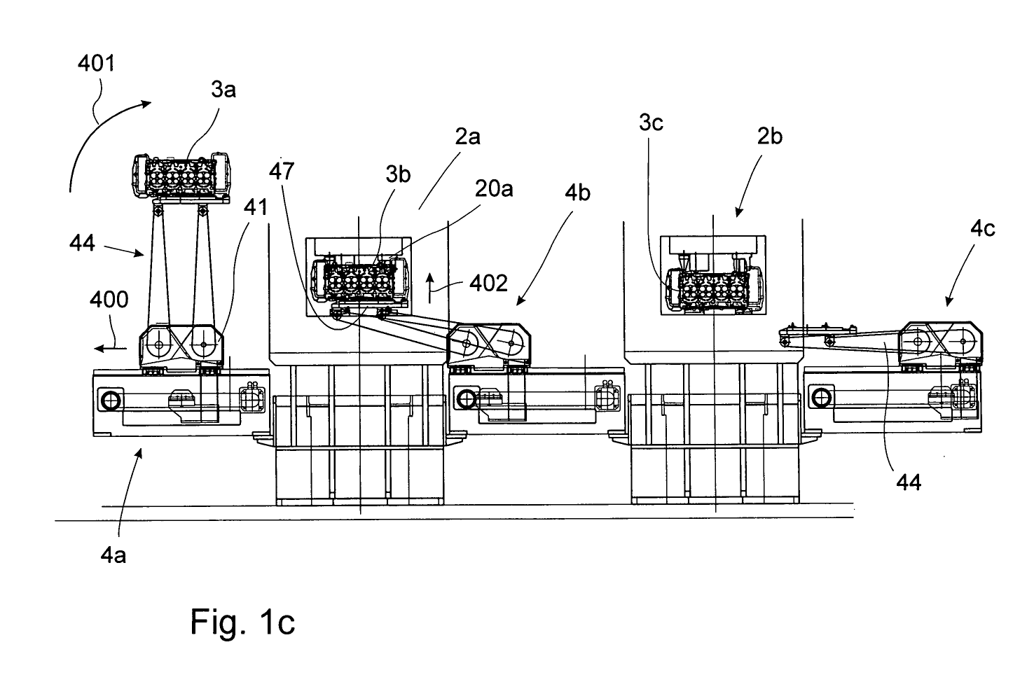

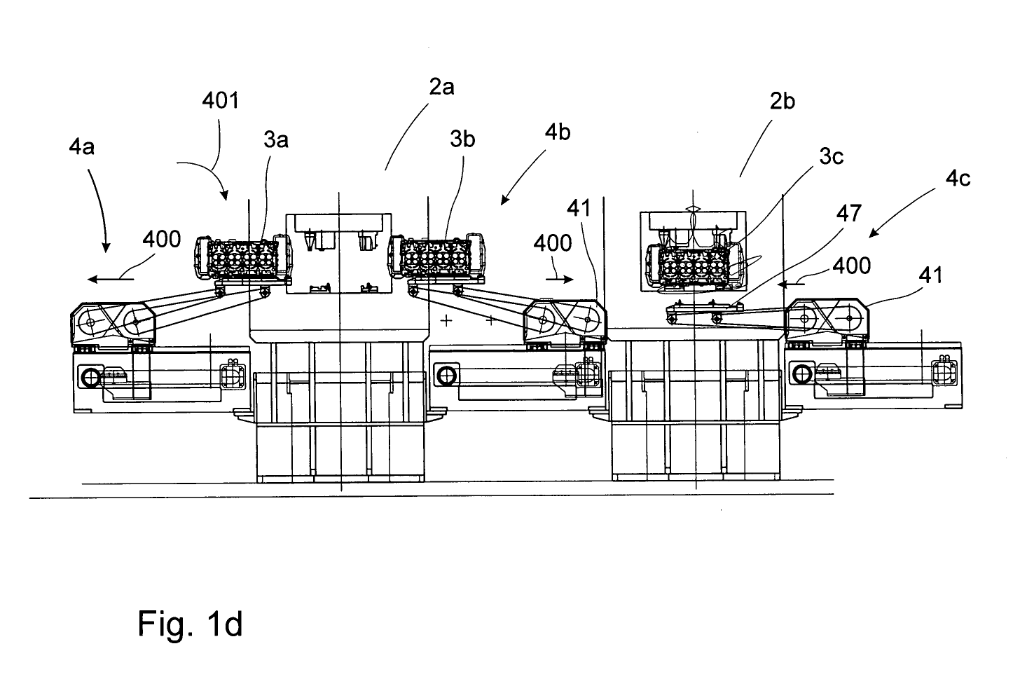

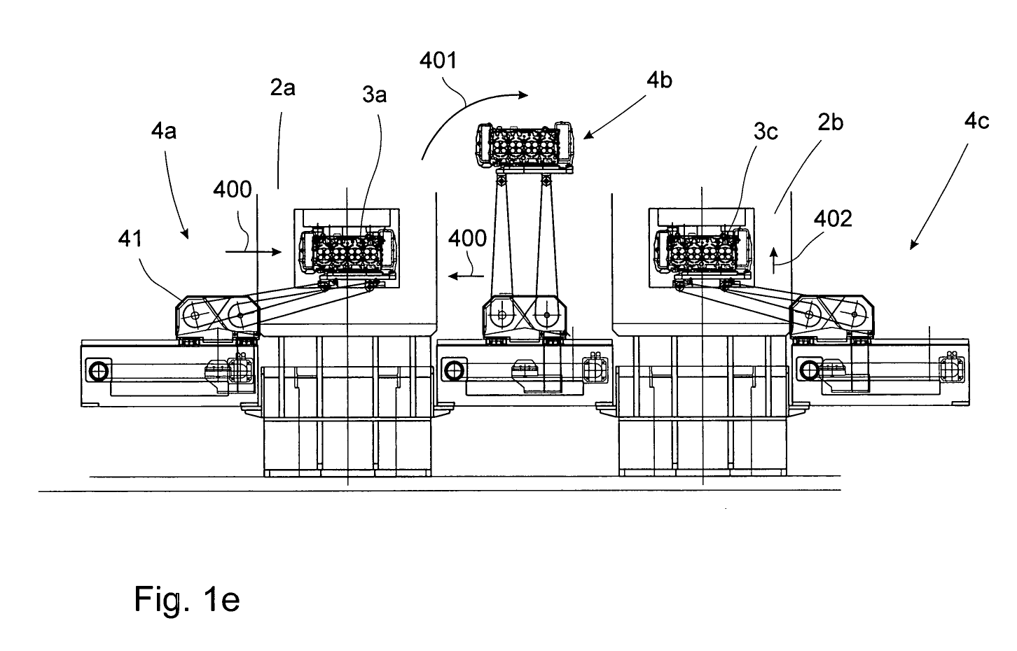

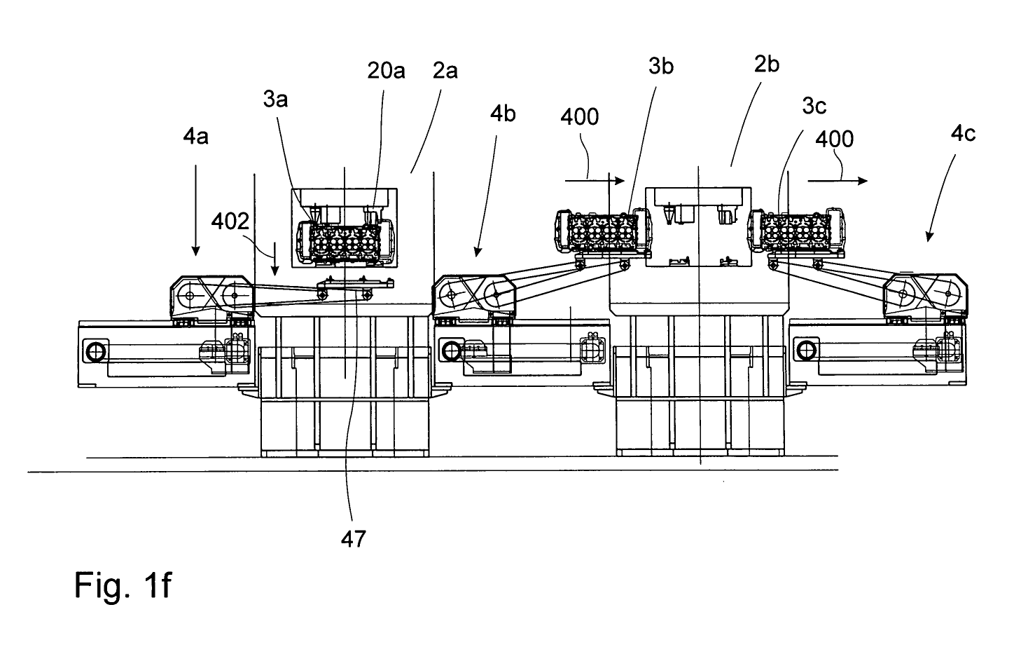

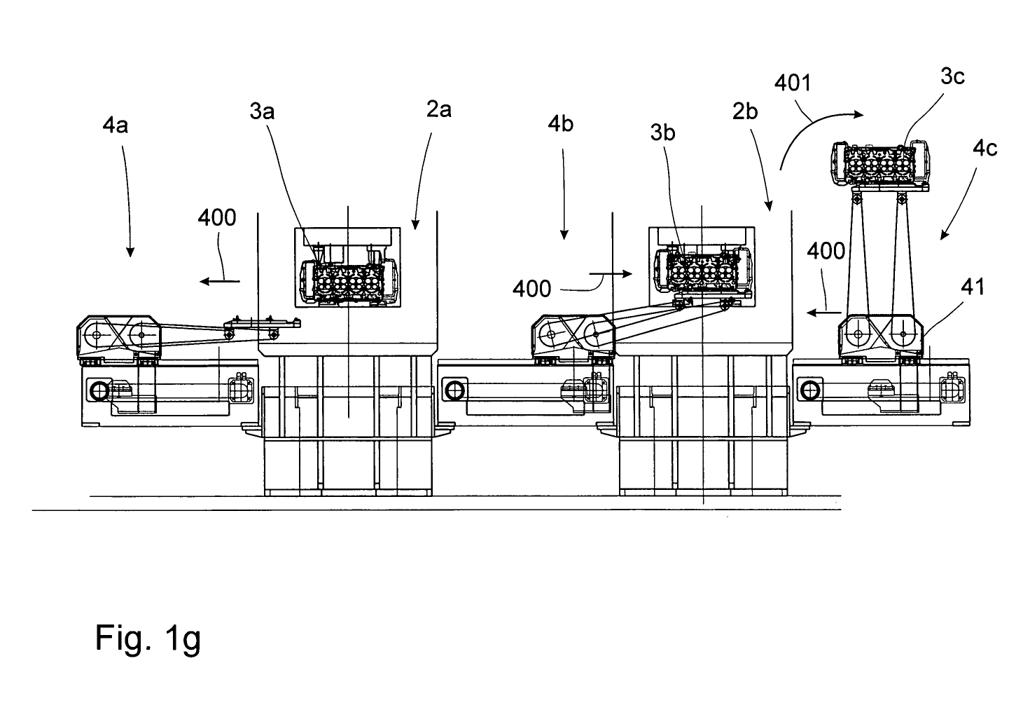

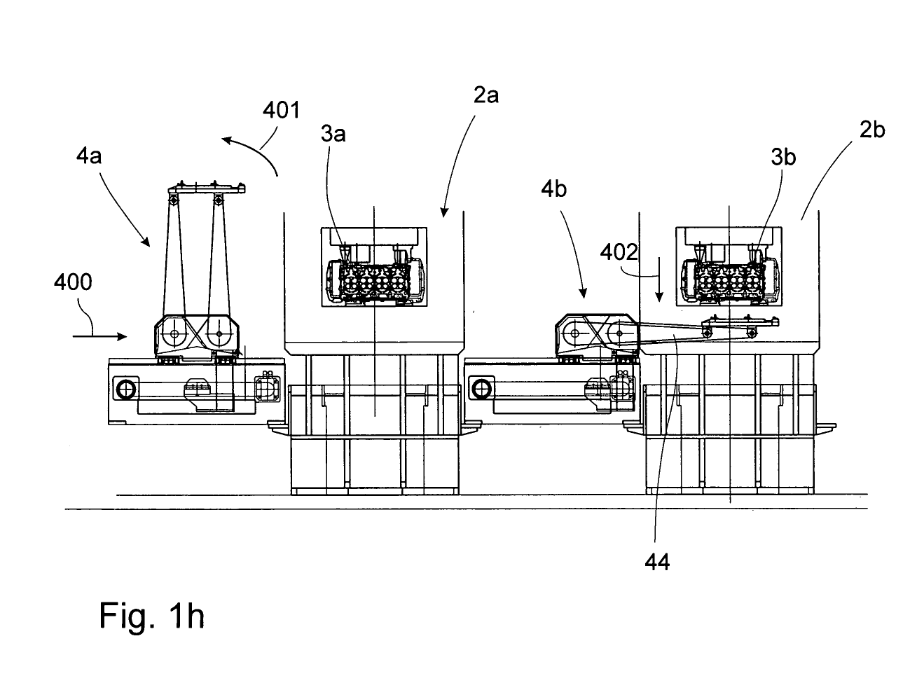

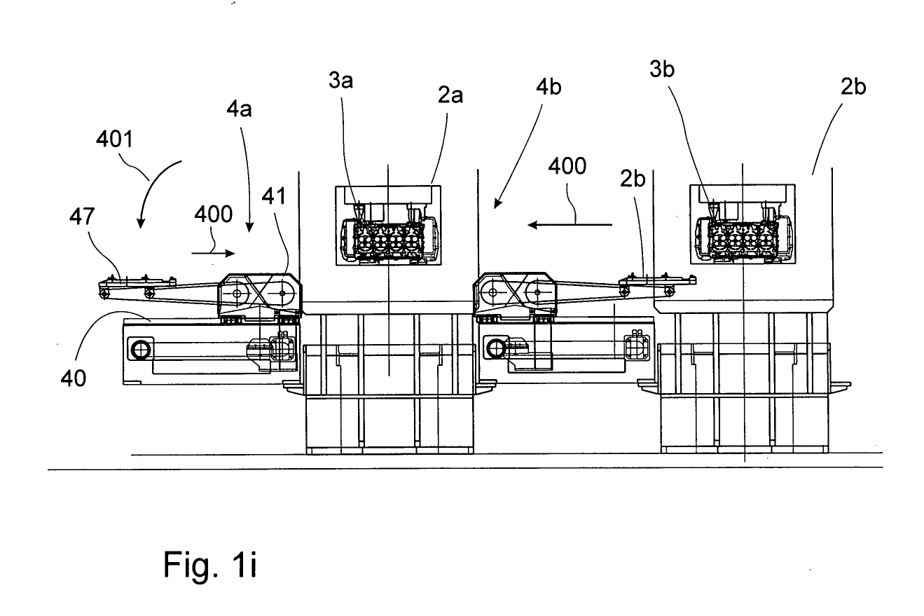

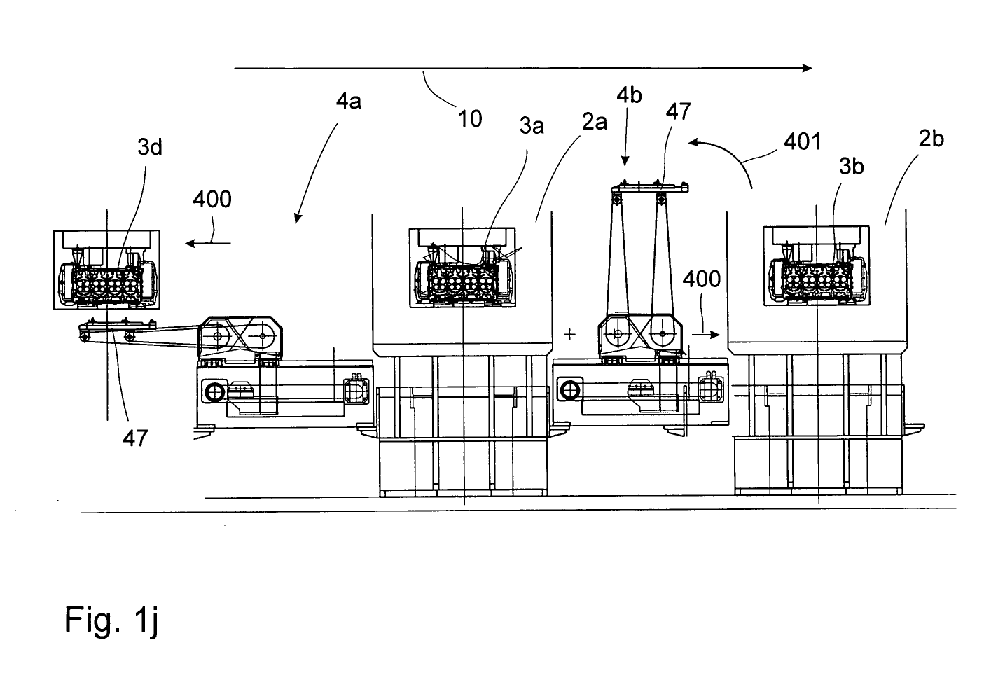

In FIG. 1a a schematic construction of a machining line 1 according to the invention is shown. The machining line comprises here a multitude of machining stations 2a, 2b arranged in the direction of movement 10 of the work pieces 3a, 3b, 3c. Between the individual machining stations 2a, 2b and so on conveying devices 4a, 4b are provided which are each driven and working independently from each other. The conveying devices 4a, 4b are supported on consoles 21 at the machining stations 2a, 2b.

The direction of movement 10 runs on the sheet from the left to the right. Thus the consequence is that the work piece 3a approached by the first conveying device 4a has to be set in as the next one in the machining station 2a. This can, of course, only be carried out when the work piece 3b in the station has been conveyed out of this first machining station 2a by means of the second conveying device 4b. This is not possible before the work piece 3b has left the second machining station 2b after the machining has been finished. The conveying devices 4a, 4b do not have, according to the embodiment shown here, a separate base or foot, but they are supported on consoles 21 provided at the machining stations 2a, 2b. For clamping the work pieces 3 in the machining stations suitable clamping devices 20a, 20b are provided. For a conveying or transfer of the work pieces 3a, 3b, 3c as stable and safe as possible the conveying device 4a, 4b has a receiving table 47 held by a lug 44.

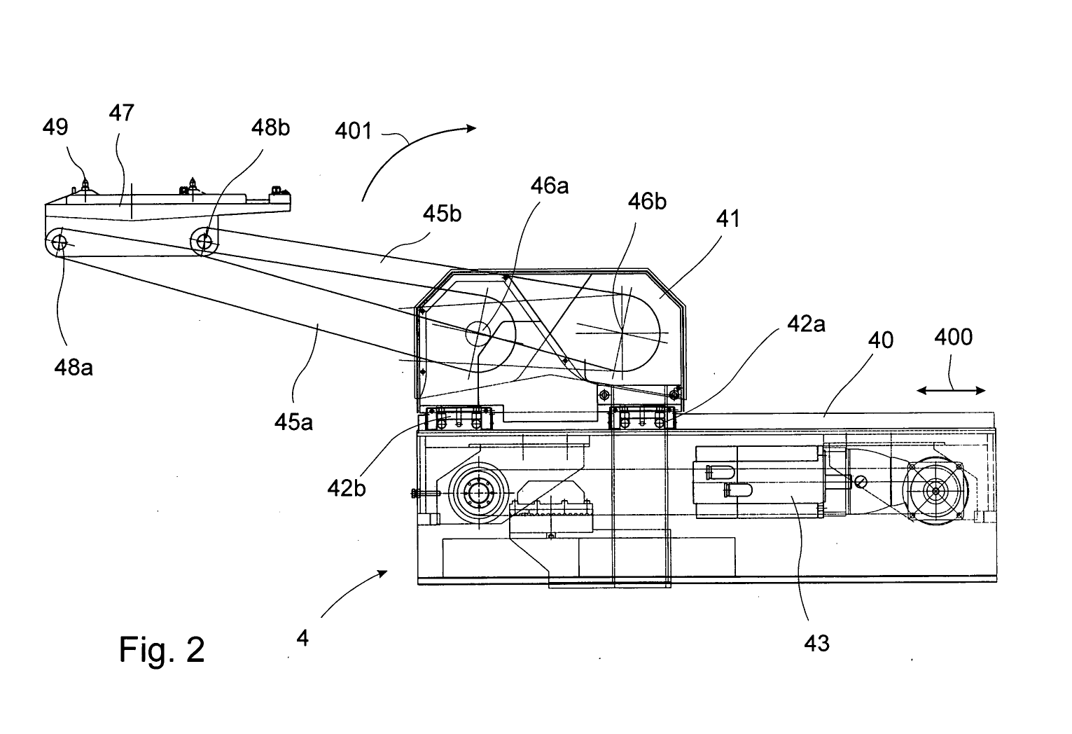

The exact design of the conveying device 4, 4a and 4b can be seen in particular in the drawing of FIG. 2.

A base 41 can move linear on a guide rail 40 via two slides 42a, 42b along the double arrow in the direction 400. For driving the base 41a drive 43 is provided below the guide rail 40. The driving concept may be designed here in any way, a ball bearing screw or a belt, tape or chain drive may be chosen. The drive can be controlled and positioned exactly.

The base 41 carries the lug 44. The lug again holds the work piece 3.

In the embodiment shown here the lug 44 is formed by two lug rods 45a, 45b arranged parallel to each other. Alternatively it is, of course, also possible that a suitable cross slide guide is arranged at the base 41, and thus the height of the lug can be adjusted.

The conveying device presented here, however, follows another concept. The two lug rods 45a, 45b are part of a parallelogram guide of the receiving table 47. For that purpose the two lug rods 45a, 45b are supported flexibly in the base 41 in base joints 46a, 46b. The distance of the base joints 46a, 46b corresponds with the distance of the two table joints 48a, 48b by which the lug rods 45a, 45b are connected flexibly with the receiving table 47.

A swing drive not shown in detail now allows to swing and position exactly the lug 44 along the swing line 401 in a controlled way so that by means of this parallelogram guide the orientation of the receiving table 47 is always the same independently from the angle of swinging.

The receiving table 47 carries the positioning supports 49 interacting with the work pieces in a suitable way, and makes a safe support of the work piece 3 during the transfer possible.

In FIGS. 1a to 1k the complete changing process of the two shown machining stations 2a, 2b is shown. The situation in FIG. 1a is such that the two machining stations 2a, 2b are in machining, the second conveying device 4b is waiting in a pick-up-waiting position just behind (with respect to the direction of movement 10) the first machining station 2a, and the first conveying device 4a has already picked up a work piece 3a in order to convey it to the first machining station 2a.

In FIG. 2b the machining in the first machining station 2a has been finished or almost finished. The second conveying device 4b is therefore on its guide rail 40 along the arrow 400 shifted to the left (with respect to FIG. 1a) in order to position its receiving table 47 below the work piece 3b.

The machining in the machining station 2b has not yet been finished.

In the position shown in FIG. 1c now also the second machining station 2b is about to finish its machining. The lug 44 of a third conveying device 4c is just being positioned in the direction of movement 10 behind the second machining station 2b in order to take over the finished work piece 3c.

In the first machining station 2a in the meantime the receiving table 47 has been positioned below the work piece 3b in such a way that the clamping device 20a can be relieved in order to forward the work piece 3b on the receiving table 47 to the second conveying device 4b.

As it becomes clear that the first machining station 2a is about to be emptied already the work piece 3a is brought into position by means of the first conveying device 4a. For that purpose the lug 44 is swilled clockwise 401 and, at the same time, the base 41 of the first conveying device 4a is shifted to the left (arrow 400).

The vertical movement 402 of the receiving table 47 of the second conveying device 4b is reached here by a clever superimposing of the swivelling movement 401 and the linear movement 400. Actually, here the horizontal movement share of the swivelling movement 401 is compensated by an opposite (horizontal) linear movement 400 so that the vertical movement 402 results. For that the swivelling angle is measured and compensated with the known trigonometric function the shifting in horizontal direction.

As the second conveying device 4b was, for the time being, unloaded (see FIGS. 1a, 1b), this conveying device 4b can now be used for removing the work piece 3b from the machining station 2a, so it's the same whether the second machining station 2b has already finished the machining of the work piece 3c or not. In any case at least for a short time the work piece 3b is buffered in the second conveying device 4b (e.g. for testing or turning steps), until it can be placed in the then empty second machining station 2b. In the first machining station 2a which has become free by that then the work piece 3a supplied in the first conveying device 4a can be placed and be clamped by the clamping device 20a.

In FIG. 1c it can be seen clearly that the machining cycles in the machining line according to the invention are different in the different machining stations 2a, 2b. The machining station 2a is in a work piece changing position, the machining station 2b is still in machining mode.

In FIG. 1d it is shown that the first machining station 2a for changing and exchanging the work pieces 3a, 3b is in changing position, and in the second machining station 2b the exchanging of the work piece 3c is immediately imminent as the base 41 of the third machining station 4c has been shifted to the left (arrow 400), in order to position the receiving table 47 below the work piece 3c. In the meantime the work piece 3b has been taken out of the machining station 2a by the conveying device 4b. For that the base 41 of the second conveying device 4b has been shifted to the right (arrow 400).

The work piece 3a still in the first conveying device 4a is changed next into the first machining station 2a. For that the swivelling movement already started in FIG. 1c is continued clockwise with a linear movement 400 in opposite direction (to the left). By means of that the receiving table 47 with the work piece 3a on it is lowered down to the level where the work piece 3a can be moved suitably into the machining station 2a for clamping on the clamping device 20a.

Also in FIG. 1e both machining stations 2a, 2b are standing still. In the right machining station 2b the finished work piece 3c is just handed over to the receiving table 47 of the third conveying device 4c; for that the receiving table 47 is just carrying out a vertical movement 402.

It is mentioned at this point that achieving the vertical movement 402, everywhere where it is used, is carried out in the same way as it is described, for example, for FIG. 1c.

The work piece 3b just removed from the first machining station is now between the two machining stations 2a, 2b in the second conveying device 4b.

By a shifting movement clockwise and a linear movement 400 in opposite direction to it to the left the work piece 3b is now brought in the range of the second machining tool 2b.

The first conveying device 4a is just placing the work piece 3a into the first machining station 2a. For that the base 41 is shifted to the right (arrow 400) on the guide rail 40. An additional turning movement is not necessary anymore; this has already been finished in the sequence according to FIG. 1d.

In FIG. 1f the machining station 2a can just begin with the machining of the work piece 3a. The machining station 2b is still in the changing position. The work piece 3a has been taken over by the clamping device 20a from the first machining station 2a and clamped in position. Thus it is possible that the receiving table 47 is lowered (arrow 402). This movement also is reached, as described in FIG. 1c, by a clever superimposing of the swivelling and linear movement.

In the machining station 2b now the situation is as in FIG. 1d for the first machining station 2a. The just finished work piece 3c is conveyed out by the conveying device 4c along arrow 400, the work piece 3b supplied in waiting position before the first machining station 2b is conveyed in by a linear movement to the right (arrow 400) in the machining station 2b.

In FIG. 1g the machining station 2b is just before the resumption of machining, in contrast to that the machining in the machining station 2a has already begun some time before. It has to be taken into consideration here that the machining in the machining station 2a can already be started when the receiving table 47 of the first conveying device 4a is still not completely retreated. It has only to be made sure that there are no collisions.

The work piece 3c is being transferred in the conveying device 4c to the next machining station not shown anymore. This is carried out by a superimposing of the swivelling movement 401 (clockwise) and the retreating movement of the base 41 to the left (arrow 400).

In the meantime also the second conveying device 4b has placed the work piece 3b in the machining station 2b. This has been done by a linear movement 400 to the right.

In FIG. 1h machining the work piece 3a in the first machining station 2a is underway. In the second machining station 2b machining the work piece 3b is starting. The lug 44 of the second conveying device 4b is not yet retreated completely, however, it is lowered vertically downward (arrow 402). The first conveying device 4a, empty at the moment, is just swinging anti-clockwise to the left in order to reach the position after the machining station arranged before (not shown). Here also a linear movement 400 in the opposite direction to the right is provided.

In FIG. 1i machining of both work pieces 3a, 3b in the machining stations 2a, 2b is underway. The second conveying device 4b is set back linear to the left, the receiving table 47 of the second conveying device 4b, however, is still in the region of the second machining tool 2b. For that the situation in the first conveying device 4a has already been continued. The receiving table 47 of the first conveying device 4a has already been swung to the left (anti-clockwise 401), the base 41 on the guide rail 40 is completely shifted to the right (400).

As described, the conveying devices 4a, 4b get again in position during machining in the machining stations 2a, 2b in order to be able to take over the finished work pieces from the machining stations arranged before. For that purpose the first conveying device 4a in FIG. 1k is shifted linear to the left in order to bring the receiving table 47 below the work piece 3d of a machining tool arranged before which is indicated furthermore.

The receiving table 47 of the second conveying device 4b is right now in back-swinging movement; this back-swinging movement is here always combined with a linear movement in the opposite direction 400 so that no collision occurs with the machining station. Furthermore, this arrangement is convenient as between the machining stations there is, in particular, space above which can be used by the swinging movement 401.

The process than goes on with FIG. 1a with the premise that the work piece shown in FIG. 1k corresponds with the work piece 3a in FIG. 1a. All work pieces have in the meantime been gone one machining station further to the right in the direction of the movement 10 and have been machined.

In FIG. 10 a modification of the design according to FIG. 2 is shown. In the embodiment shown here the base 41 is not connected directly to the slides 42a, 42b, but between the base 41 and the slides 42a, 42b there is the swivel joint 60. By means of that it is possible to rotate the base 41 and the lug 44 connected to it around a vertically orientated rotational axis 62. The two slides 42a, 42b are here connected to each other by a connecting plate 61, and carry on the upper face a part of the swivel joint 60, the other part of the swivel joint 60 is located on the underside of the base 41.

As already described, the lug 44 comprises two parallel arranged lug rods 45a, 45b. The arrangement is here chosen in such a way that the position of the table joints 48a, 48b (defined by their rotational axes) can be lowered to the level of the base joints 46a, 46b (defined by their rotational axes) or even below. This is achieved by a special design of the lug rods 45a, 45b which have bendings at right angles or recesses in a suitable way. By means of that the mobility and flexibility of the conveying device according to the invention is increased accordingly.

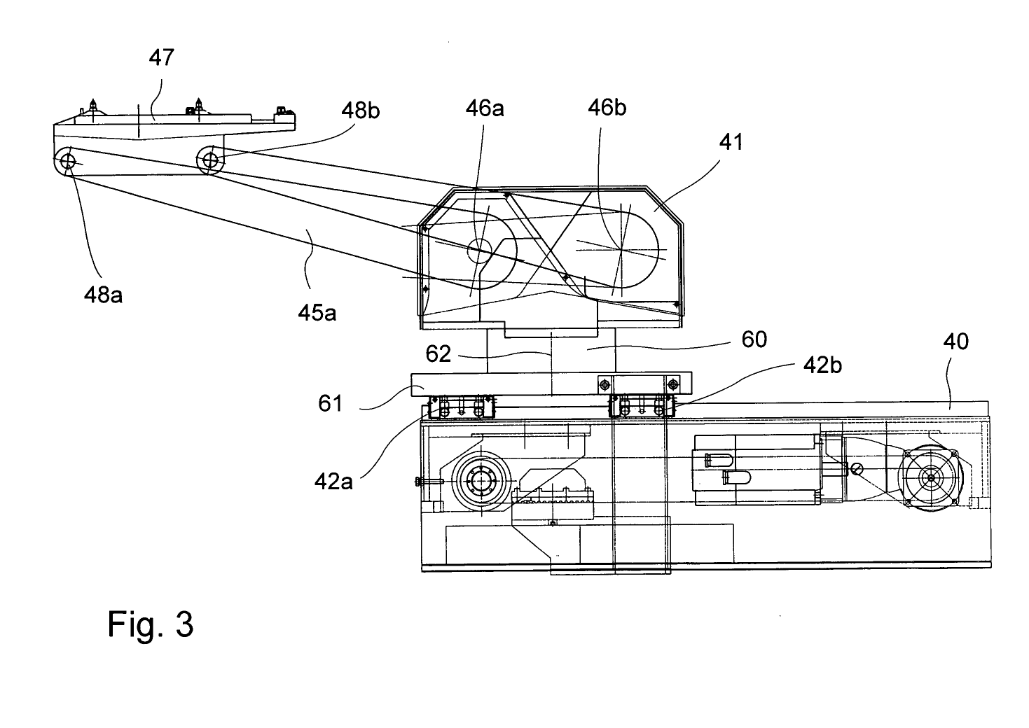

In the modification according to FIG. 3 it may be possible to rotate the lug 44 around a vertical axis 62, however, it is not possible to carry out a retreating movement. For the retreating movement also a linear movement is required, namely parallel to the longitudinal extension of the lug 44. This parallelism is not given anymore with swivelling around the swivel joint 60, so that a retreating movement is not possible in the modification shown here.

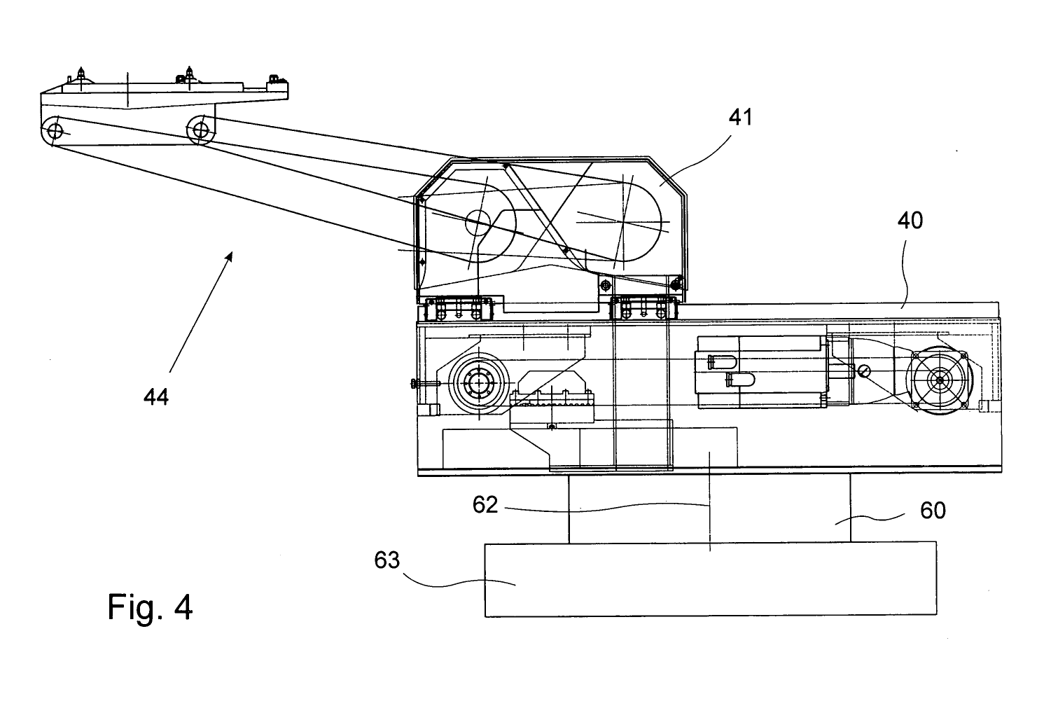

This disadvantage, however, is removed by the suggestion according to FIG. 4 where the swivel joint 60 is provided below the guide rail 40. A base plate 63 is provided which holds on its upper side the first part of the swivel joint 60. The guide rail 40 has, of course, a certain thickness as in it also the drive for the base 41 is provided. On the underside (opposite the slide 42a, 42b) of the guide rail 40 the other part of the swivel joint 60 is provided. This modification also allows a turning around a vertical axis 62, however, with the advantage that then also with a twisted movement a depositing movement or retreating movement is possible as the parallelism of the guide rail 40 and of the longitudinal extension of the lug 44 is not interfered with or interrupted by a swinging movement. By means of the suggestion according to FIG. 3 or, in particular, according to FIG. 4 it is possible to transfer work pieces outward out of the machining line or to realise suitable switches and the like.

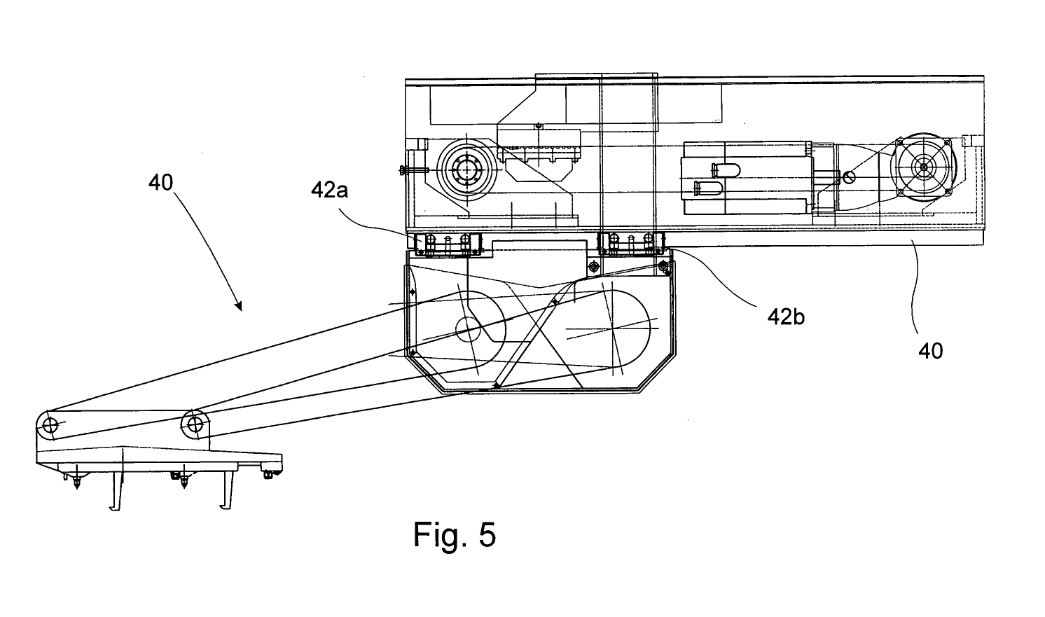

The solution according to the FIGS. 2, 3 and 4 shows an upright construction. This means that the slides 42a, 42b glide on the guide rail 40. In contrast to that FIG. 5 shows a suspended arrangement where the guide rail 40 is located above the slides 42a, 42 in the application case. Of course, in this example as well all combinations with the swivel joints can be used, even if they are not shown.

Although the invention has been described by exact examples which are illustrated in the most extensive detail, it is pointed out that this serves only for illustration, and that the invention is not necessarily limited to it because alternative embodiments and methods become clear for experts in view of the disclosure. Accordingly changes can be considered which can be made without departing from the contents of the described invention.

1. Machining line, in particular transfer line or assembly line, comprising a multitude of machining stations arranged one after the other in the direction of machining, and the machining stations serve for the machining of work pieces wherein at least one machining station is designed as special machine, wherein between two adjoining machining stations (2a, 2b) one conveying device (4a, 4b) each is provided, characterised in that the conveying movement of a first work piece (3) between a first (2a) and a second machining station (2b) is carried out independently from the conveying movement of a second work piece (3a) between a second (2b) and third machining station.

2. Machining line according to claim 1, characterised in that the conveying device (4a, 4b) removes the work piece (3) from the machining station (2a, 2b) and/or puts it in the machining station (2a, 2b) or in a clamping device (20a, 20b), respectively, provided in the machining station (2a, 2b).

3. Machining line according to claim 1, characterised by a combined linear and swinging movement of the work piece (3) by the conveying device (4a, 4b), or an optional distance between the machining stations (2a, 2b).

4. Machining line according to claim 1, characterised in that in the machining line a multitude of conveying devices (4a, 4b, 4c) is provided, and the conveying devices (4a, 4b, 4c) can be selected independently from each other.

5. Machining line according to claim 1, characterised by different machining stations (2a, 2b, . . . ) and/or conveying lines (4a, 4b, . . . ) and the possibility to place it spatially flexibly.

6. Machining line according to claim 1, characterised in that the conveying devices (4a, 4b, 4c) are provided in a way that they can be engaged and/or disengaged with each other with respect to the conveying movement, or at least one conveying device (4a, 4b, 4c) has means for changing the position of the work piece (3) to be conveyed.

7. Machining line according to claim 1, characterized in that that at least one conveying device (4a, 4b, 4c) is provided at the same time as interim place of deposit for at least one work piece (3), or the interim place of deposit is designed as testing point.

8. Machining line according to claim 1, characterized in that at the conveying device (4a, 4b, 4c) at least one means for measuring and/or testing is arranged, or the means for measuring and/or testing is designed in such a way that it can carry out the testing during the conveying from one machining station (2a, 2b) to the next.

9. Machining line according to claim 1, characterised in that at least at one conveying device (4a, 4b, 4c) means for rotating and/or swinging, at least around a horizontal and/or vertical axis, are provided, or at least in one machining station (2a, 2b) a circular table is provided for the clamping device.

10. Machining line according to claim 1, characterised in that the conveying device (4a, 4b, 4c) has at least one means for setting in or removing the work piece from the machining station (2a, 2b) or in the machining station (2a, 2b) or its clamping device (20a, 20b), or the means for setting in and/or removing is designed as gripper.

11. Machining line according to claim 1, characterised in that the machining stations (2a, 2b) are arranged to each other with a differing distance which can be selected freely, or the conveying device (4a, 4b, 4c) has two linear axes arranged orthogonal to each other in order to carry out movements of the work piece (3) in these directions.

12. Machining line according to claim 1, characterised in that the conveying device (4a, 4b, 4c) has two linear axes arranged orthogonal to each other in order to carry out movements of the work piece (3) in these directions, and a cross table is provided which offers the second orthogonal axis, or the conveying devices (4a, 4b, 4c) are supported on consoles (21) provided at the machining stations (2a, 2b).

13. Conveying device for a machining line, comprising a multitude of machining stations arranged one after the other in the direction of machining, and the machining station serves for machining work pieces, wherein at least one machining station is designed as special machine, wherein between two adjoining machining stations (2a, 2b) one conveying device (4a, 4b) each is provided, wherein the conveying device (4a, 4b, . . . ) has at least one slide (42a, 42b) which can be positioned on a guide rail (40) and a lug (44) which can be lifted or lowered, in particular be swung, and the lug holds the work piece (3).

14. Conveying device for a machining line wherein the conveying device (4a, 4b, . . . ) has at least one slide (42a, 42b) which can be positioned on a guide rail (40), and a lug (44) which can be lifted or lowered, in particular be swung, and the lug holds the work piece (3), characterised in that a swivel joint (60) is provided below the guide rail (40), and a base plate (63) of a base (41) holds a first part of the swivel joint, and at the side opposite the slide (42a, 42b) the part of the swivel joint or a conveying device for a machining line is arranged.

15. Conveying device according to claim 13, characterized in that a guide rail (40) is provided through which preferably through the slides (42a, 42b) a base can be moved linear in the direction (400).

16. Conveying device according to claim 13, characterised in that a guide rail (40) is provided through which preferably through the slides (42a, 42b) a base can be moved linear in the direction (400), and a drive (43) is provided for the base (41), and the drive (43) is arranged preferably below the guide rail (40).

17. Conveying device according to claim 13, characterized in that a guide rail (40) is provided through which preferably through the slides (42a, 42b) a base can be moved linear in the direction (400), and a drive (43) is provided for the base (41), and the drive (43) is arranged preferably below the guide rail (40), and as drive (43) a ball bearing screw, a belt, tape or chain drive or the like is provided.

18. Conveying device according to claim 13, characterised in that at the conveying device (4a, 4b, . . . ) a lug (44) is provided which is preferably formed by two lug rods (45a, 45b) arranged parallel to each other.

19. Conveying device according to claim 13, characterised in that the lug (44) has means for holding directly and/or indirectly the work piece (3), and the lug (44) is designed turnable.

20. Conveying device according to claim 13, characterised in that the height of the lug (44) can be adjusted by means of a cross slide guide arranged at the base (41), or slug supports (45a, 45b) are provided, and the lug rods (45a, 45b) are part of a parallelogram guide of the receiving table (47).

21. Conveying device according to claim 13, characterised in that lug rods (45a, 45b) are provided, and the lug rods (45a, 45b) are supported flexibly in base joints (46a, 46b) in the base (41), or two table joints (48a, 48b) are provided by means of which the lug rods (45a, 45b) are connected flexibly with the receiving table (47).

22. Conveying device according to claim 13, characterised in that base joints (46a, 46b) are provided, and the distance of the base joints (46a, 46b) corresponds with the distance of the table joints (48a, 48b), or a swinging drive is provided through which the lug (44) can be swung and positioned controlled along a turning line (401).

23. Conveying device according to claim 13, characterised in that at least one positioning support (49) is provided at a receiving table (47) interacting with the work pieces (3) for a save support of the work piece (3) in particular during transfer.

24. Conveying device according to claim 13, characterized in that the swivel joint (60) between the base (41) and the slides (42a, 42b) is provided by means of which the base (41) with the lug (44) arranged at it can be rotated around a vertically orientated rotational axis (62), or the slides (42a, 42b) are connected with one another by a connecting plate (61).

25. Conveying device according to claim 13, characterized in that a connecting plate (61) is provided, and the connecting plate (61) carries a part of a swivel joint (60), and the other part of the swivel joint is arranged on the underside of the base.

26. Conveying device according to claim 13, characterised in that the lug has lug rods, and the lug rods (45a, 45b) are bent at right angles, or have recesses.

27. Conveying device according to claim 13, characterized in that a swivel joint (60) is provided below the guide rail (40), and a base plate (63) holds the first part of the swivel joint (60), the other part of the swivel joint being arranged on the side of the guide rail (40) opposite the slides (42a, 42b).

28. Conveying device according to claim 13, characterized by a suspending arrangement of the slides (42a, 42b) at the guide rail (40), or in that the slides (42a, 42b) are able to glide through an upright construction on the guide rail (40).

29. Conveying device according to claim 14, characterised in that a guide rail (40) is provided through which preferably through the slides (42a, 42b) a base can be moved linear in the direction (400), and a drive (43) is provided for the base (41), and the drive (43) is arranged preferably below the guide rail (40).

30. Conveying device according to claim 14, characterised in that a guide rail (40) is provided through which preferably through the slides (42a, 42b) a base can be moved linear in the direction (400), and a drive (43) is provided for the base (41), and the drive (43) is arranged preferably below the guide rail (40), and as drive (43) a ball caster spindle, a belt, tape or chain drive or the like is provided.

31. Conveying device according to claim 14, characterised in that at the conveying device (4a, 4b, . . . ) a lug (44) is provided which is formed preferably from two lug rods (45a, 45b) arranged parallel to each other, or the lug (44) has means for directly and/or indirectly holding the work piece (3), and the lug (44) is designed turnable.

32. Conveying device according to claim 14, characterised in that the height of the lug (44) can be adjusted by means of a cross slide guide arranged at the base (41), or lug supports (45a, 45b) are provided, and the lug rods (45a, 45b) are part of a parallelogram guide of the receiving table (47), or lug rods (45a, 45b) are provided, and the lug rods (45a, 45b) are supported flexibly in the base joints (46a, 46b) in the base (41), or two table joints (48a, 48b) are provided through which the lug rods (45a, 45b) are connected flexibly with the receiving table (47).

33. Conveying device according to claim 14, characterised in that base joints (46a, 46b) are provided, and the distance of the base joints (46a, 46b) corresponds with the distance of the table joints (48a, 48b), or a swinging drive is provided through which the lug (44) can be swung and positioned controlled along a turning line (401), or at least one positioning support (49) is provided at a receiving table (47) interacting with the work pieces (3) for a save support of the work piece (3), in particular during the transfer.

34. Conveying device according to claim 14, characterised in that the turning joint (60) is provided between the base (41) and the slides (42a, 42b) by means of which the base (41) with the lug (44) arranged at it can be rotated around a vertically orientated rotational axis (62), or the slides (42a, 42b) are connected to one another by a connecting plate (61), or a connecting plate is arranged, and the connecting plate (61) carries a part of a swivel joint (60) and the other part of the swivel joint is arranged on the underside of the base.

35. Conveying device according to claim 14, characterised in that the lug has lug rods, and the lug rods (45a, 45b) are bent at right angles or have recesses or a suspending arrangement of the slides (42a, 42b) at the guide rail (40), or in that the slides (42a, 42b) are able to glide through an upright construction on the guide rail (40).
